(19) United States
(12) Patent Application Publication
(10) Pub. No.: US 2021/0366489 A1
(43) Pub. Date: Nov. 25, 2021

(54) VOICE AUTHENTICATION SYSTEM AND METHOD

(71) Applicant: AURAYA PTY LTD, Hornsby NSW (AU)

(72) Inventors: Clive Summerfield, Hornsby (AU); Jamie Lister, Hornsby (AU)

(73) Assignee: AURAYA PTY LTD, Hornsby NSW (AU)

(21) Appl. No.: 16/606,464

(22) PCT Filed: Apr. 19, 2018
(86) PCT No.: PCT/AU2018/050351

§ 371 Date: Oct. 18, 2019

(30) Foreign Application Priority Data
Apr. 19, 2017 (AU) 2017901431

(51) Int. Cl. G10L 17/04; G06F 21/32; G10L 17/06

(52) U.S. Cl. CPC G10L 17/04; G10L 17/06; G06F 21/32

(57) ABSTRACT

A method for setting the false acceptance (FA) rate of an individual voiceprint used for enrolling a user with a voice biometric authentication system, the individual voiceprint derived from a Universal Background Model (UBM) selected by the system, the method comprising: (a) selecting a cohort of impostor voice files containing voice samples spoken by persons other than the enrolling user; (b) determining one or more acoustic feature files for each voice file in the selected cohort of impostor voice files; (c) determining, for each acoustic feature files, the top n GMM mixture components for the selected Universal Background Model (UBM); (d) scoring the acoustic features against only the corresponding top n mixture components in the individual voiceprint to generate a distribution of impostor scores; and (e) setting the FA rate for the individual voiceprint based on the resultant distribution.

### FIELD OF THE INVENTION

This invention relates to a voice authentication system and method and more particularly to optimisation techniques for achieving a target false accept rate for the system.

### BACKGROUND OF THE INVENTION

Voice authentication systems are becoming increasingly popular for providing secure access control. For example, voice authentication systems are currently being utilised in telephone banking systems, automated proof of identity applications, in call centres systems (e.g. deployed in banking financial services), building and office entry access systems, and the like.

Voice authentication (also commonly referred to as “verification”) is typically conducted over a telecommunications network, as a two-stage process. The first stage, referred to as the enrolment stage, involves processing a sample of a user's voice by a voice authentication engine to generate acoustic features from which a voiceprint is compiled. Thus, the voiceprint represents acoustic attributes unique to that user's voice. The second stage, or authentication stage, involves receiving a voice sample of a user to be authenticated (or identified) over the network. Again, the voice authentication engine generates the acoustic features of the sample and compares the resultant acoustic features with the enrolled voiceprint to derive an authentication score indicating how closely the voice sample matches the voiceprint and therefore the likelihood that the user is, in fact, the same person that enrolled the voiceprint at the first stage. This score is typically expressed as a numerical value and involves various mathematical calculations that can vary from engine to engine.

In the case of the correct, or “legitimate”, user accessing the authentication system, the expectation is that their acoustic features (i.e. generated from their verification voice sample) will closely match the enrolled voiceprint for that user, resulting in a high score. If a fraudster (often referred to in the art as an “impostor”) is attempting to access the system using the legitimate user's information (e.g. voicing their password, etc.), the expectation is that the impostor's acoustic features will not closely match the legitimate user's voiceprint, thus resulting in a low score even though the impostor is quoting the correct information.

Whether a user is subsequently deemed to be legitimate is typically dependent on the threshold set by the authentication system. To be granted access to the system, the score generated by the authentication system needs to exceed the threshold. If the threshold score is set too high then there is a risk of rejecting large numbers of legitimate users. This is known as the false rejection rate (FRR). On the other hand, if the threshold is set too low there is a greater risk of allowing access to impostors. This is known as the false accept rate (FAR).

As one would appreciate therefore, selecting an appropriate threshold for an authentication system can be difficult to achieve. On one hand the threshold setting needs to be high enough that business security requirements of the secure services utilising the authentication system are met. However, such settings can cause undue service issues with too many legitimate users being rejected. Similarly, if the threshold is set too low, while achieving good services levels, security may be put at risk. The problem of selecting appropriate threshold settings is compounded by the fact that different authentication engines utilise different attributes or characteristics for acoustic feature and voiceprint comparison and as a result may produce a wide range of different scores based on the same type of content provided in the voice samples (e.g. numbers, phrases, etc.). What is more a voice authentication system will also produce quite different scores for voice samples produced by different users. Further, it will also produce different scores for different content types, for example an account number compared to a date of birth, a phrase, a randomly generated phrase or number string or conversational speech.

### SUMMARY OF THE INVENTION

In accordance with a first aspect of the present invention there is provided a method for achieving a target false acceptance (FA) rate by setting individual acceptance thresholds for respective voiceprints used for enrolling users with a biometric authentication system, each individual voiceprint derived from a Universal Background Model (UBM) selected by the system, the method comprising: (a) selecting a cohort of impostor voice files containing voice samples spoken by persons other than the enrolling user; (b) determining one or more feature vectors for each voice file in the selected cohort of impostor voice files; (c) determining and selecting, for each feature vector of each impostor voice file, GMM mixture components for the selected Universal Background Model (UBM); (d) scoring the acoustic parameter vectors against only a predefined number of the top n mixture components in the individual voiceprint to generate a distribution of impostor scores; and (e) evaluating the resultant distribution to determine an acceptance threshold for achieving the target FA rate.

In an embodiment steps (d) and (e) are implemented in real time during enrolment with the system.

In an embodiment the method further comprises setting a target FA rate at 1 in every Y for the individual voiceprint.

In an embodiment the method further comprises selecting a cohort of impostor voice files that contains at least a multiple of Y impostor voice files.

In an embodiment, in response to determining that the false reject (FR) rate is greater than the target FR rate, the method further comprises regenerating the individual voiceprint or adjusting a security threshold for the user.

In an embodiment where n comprises between 1 and maximum number of mixture components available, but usually some number less than the maximum number of mixture components available.

In an embodiment steps (a) to (c) are implemented prior to enrolment.

In accordance with a second aspect there is provided a method for setting an acceptance threshold for an individual voiceprint to achieve a target false acceptance (FA) rate of a biometric authentication system, the method comprising: (a) selecting a cohort of acoustic feature files derived from voice samples spoken by persons other than the enrolling user; (b) for each acoustic feature file, determining a subset of mixture components for at least one UBM implemented by the system to be used in an impostor testing process; (d) implementing an impostor testing process, the impostor testing process comprising implementing a biometric authentication engine to compare each acoustic feature file against the enrolled voiceprint using only the subset of mixture components; and (e) setting the threshold based on an evaluation of one or more scores resulting from the comparisons.

In accordance with a third aspect there is provided a computer system for setting an acceptance threshold for an individual voiceprint to achieve a target false acceptance (FA) rate of a biometric authentication system, the system comprising a processing module operable to: (a) select a cohort of acoustic feature files derived from voice samples spoken by persons other than the enrolling user; (b) for each acoustic feature file, determine a subset of mixture components for at least one UBM implemented by the system; (d) implement an impostor testing process, the impostor testing process comprising implementing a biometric authentication engine to compare each acoustic feature file against the enrolled voiceprint utilising only the subset of mixture components; and (e) setting the threshold based on an evaluation of one or more scores resulting from the comparisons.

In an embodiment step (b) comprises implementing the biometric engine to score each mixture of the at least one UBM against individual acoustic features in the corresponding impostor acoustic feature file.

In an embodiment the subset of mixture components comprises components that exceeded a threshold score.

In an embodiment step (b) comprises determining and ranking, for each acoustic feature in the acoustic feature file, GMM mixture components for the at least one Universal Background Model (UBM) and wherein the subset comprises a predefined number of top ranking mixture components.

In an embodiment step (b) comprises determining and ranking, for each acoustic feature in the acoustic feature file, GMM mixture components for each Universal Background Model (UBM) implemented by the system and wherein the subset comprises a predefined number of top ranking mixture components for each UBM.

In accordance with a fourth aspect of the present invention there is provided computer program code comprising at least one instruction which, when executed by a computer, is arranged to implement the method as described in accordance with the first aspect outlined above.

### BRIEF DESCRIPTION OF THE DRAWINGS

Features and advantages of the present invention will become apparent from the following description of embodiments thereof, by way of example only, with reference to the accompanying drawings, in which:

FIG. 1 is a block diagram of a system in accordance with an embodiment of the present invention;

FIG. 2 is a schematic of the individual modules implemented by the voice processing system of FIG. 1;

FIG. 3 is a schematic illustrating a process flow for creating voiceprints;

FIG. 4 a graph illustrating the distribution of impostor scores for two different voiceprints;

FIG. 5 a chart illustrating the tails of the distribution of impostor scores showing the skewing for different voiceprints; and

FIG. 6 is a schematic illustrating a process flow for individual FA setting, in accordance with an embodiment of the invention.

### DETAILED DESCRIPTION OF PREFERRED EMBODIMENTS

Embodiments relate to techniques for utilising acoustic feature files produced by impostors to set acceptance thresholds for individual users of an authentication system to achieve a target false accept rate.

In the context of the present specification, the term “seed universal background model” (UBM) will be understood as being related to a speaker-independent Gaussian Mixture Model (GMM) trained with speech samples from a cohort of speakers having one or more shared speech characteristics.

For the purposes of illustration, and with reference to the figures, embodiments of the invention will hereafter be described in the context of a voice processing system 102 which provides voice authentication determinations for a secure service 104, such as an interactive voice response (“IVR”) telephone banking service. In the illustrated embodiment, the voice processing system 102 is implemented independently of the secure service 104 (e.g. by a third-party provider). In this embodiment, users (i.e. customers of the secure service) communicate with the secure service 104 using an input device in the form of a telephone 106 (e.g. a standard telephone, mobile telephone or IP telephone service such as Skype).

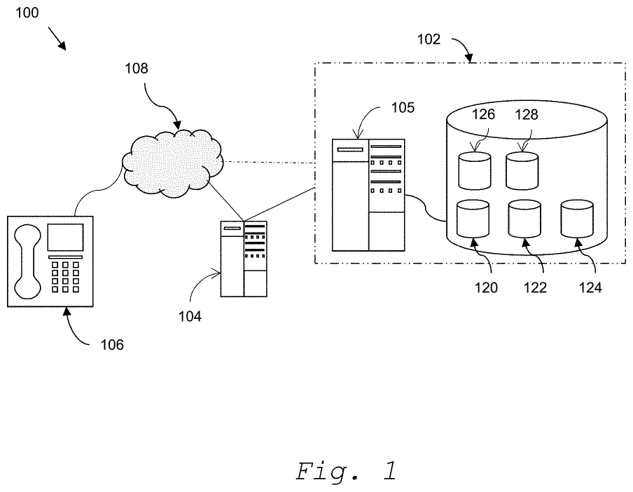

FIG. 1 illustrates an example system configuration 100 for implementing an embodiment of the present invention. As discussed above, users communicate with the telephone banking service 104 using a telephone 106. The secure service 104 is in turn connected to the voice processing system 102 which is operable to authenticate the users before they are granted access to the IVR banking service.

According to the illustrated embodiment, the voice processing system 102 is connected to the secure service 104 over a communications network in the form of a public-switched telephone network 108.

Further Detail of System Configuration—

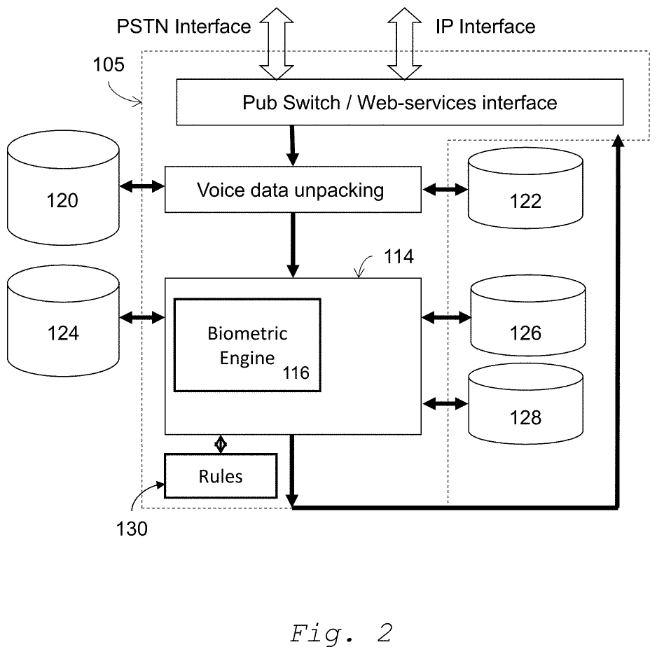

With reference to FIG. 2, the voice processing system 102 comprises a server computer 105 which includes typical server hardware including a processor, motherboard, random access memory, hard disk and a power supply. The server 105 also includes an operating system which co-operates with the hardware to provide an environment in which software applications can be executed. In this regard, the hard disk of the server 105 is loaded with a processing module 114 which, under the control of the processor, is operable to implement various voice authentication modules and threshold setting functions, as will be described in more detail in subsequent paragraphs.

As illustrated, the processing module 114 comprises a voice biometric engine 116 for carrying out authentication scoring procedures. It should be noted that the functions of the server 105 may be distributed across multiple computing devices. In particular, the voice biometrics functions need not be performed on servers. For example, they may be performed in suitably programmed processors or processing modules within any computing device. According to embodiments described herein multiple virtual computer processing units could be employed for implementing the voice biometric engine/scoring procedures.

The processing module 114 is communicatively coupled to a number of databases including an identity management database 120, acoustic feature file database 122, voiceprint database 124 and seed UBM database 126.

The processing module 114 is also communicable with an impostor database 128. The impostor database 128 stores acoustic feature files that are to be utilised for carrying out false accept rate testing on individual user's voiceprints, as will be described in more detail in subsequent paragraphs. The acoustic feature files are derived from voice files spoken by known users and are representative of the acoustic features of the user's voice contained within the voice file. Hereafter, the acoustic feature files stored in the database 128 will be referred to as “impostor feature files”. As persons skilled in the art will appreciate, the biometric engine 116 is implemented to perform a front-end acoustic analysis on the impostor voice files to generate the impostor feature files. Further, since the impostor feature files are not waveform or speech signals, they cannot be played and listened to and, thus, are in effect encrypted.

For added security for text-dependent and text-independent verification, the sequence of acoustic features within each file may be scrambled, since the sequencing of the acoustic features does not have a bearing on the scoring process implemented by the voice biometric engine 116.

In a particular embodiment, the impostor database 128 comprises impostor feature files of users who have previously been successfully authenticated by the processing system 102 (and thus known to the system). In other words, the database 128 may be comprised of acoustic feature files for users that have produced high authentication scores in a previous authentication session and are, therefore, assumed to be legitimate speakers.

The impostor feature files stored in the impostor database 128 may be categorised according to a content type and/or speaker characteristic (e.g. voice item, gender, age group, accent and other linguistic attributes, or some other specified category). The information used to categorise the files may be determined from information provided by the corresponding user during enrolment. In an embodiment, only impostor feature files that share a selected content type and/or characteristic may be selected for comparison, increasing the efficiency and accuracy of the results. For example, where the voiceprint under test is associated with a male speaker speaking account numbers, only male voice files saying account numbers will be utilised for generating impostor feature files. The selected impostor files are subsequently stored in the impostor database 128.

Still with reference to FIG. 2, the processing module is communicable with a rule store 130 which stores various scoring and false acceptance setting rules implemented by the processing module 114, again as will be described in more detail in subsequent paragraphs.

The server 105 includes appropriate software and hardware for communicating with the secure service provider system 104. The communication may be made over any suitable communications link, such as an Internet connection, a wireless data connection or public network connection. In an embodiment, user voice data (i.e. the speech samples provided by users during enrolment, authentication and subsequent interaction with the secure service banking system) is routed through the secure service provider 104. Alternatively, the voice data may be provided directly to the server 105 (in which case the server 105 would also implement a suitable call answering service).

As discussed, the communication system 108 via which users 102 communicate with the processing system 102 is in the form of a public switched telephone network. However, in alternative embodiments the communications network may be a data network, such as the Internet. According to such an embodiment, users may use a networked computing device to exchange data (in an embodiment, XML code and packetised voice messages) with the server 105 using a network protocol, such as the TCP/IP protocol. Further details of such an embodiment are outlined in the published international patent application PCT/AU2008/000070, the contents of which are incorporated herein by reference. In another alternative embodiment, the communication system may additionally comprise a third, fourth or fifth generation (“3G”, “4G” and “5G”), CDMA or GPRS enabled mobile telephone network connected to the packet-switched network, which can be utilised to access the server 105. In such an embodiment, the user input device 106 includes wireless capabilities for transmitting the speech samples as data. The wireless computing devices may include, for example, mobile phones, personal computers having wireless cards and any other mobile communication device which facilitates voice recordal functionality. In another embodiment, the present invention may employ an 802.11 based wireless network or some other personal virtual network.

According to the illustrated embodiment the secure service provider system 104 is in the form of a telephone banking server. The secure service provider system 104 comprises a transceiver including a network card for communicating with the processing system 102. The server also includes appropriate hardware and/or software for providing an answering service. In the illustrated embodiment, the secure service provider 104 communicates with the users over a public-switched telephone network 108 utilising the transceiver module.

Voiceprint Enrolment/Generation—

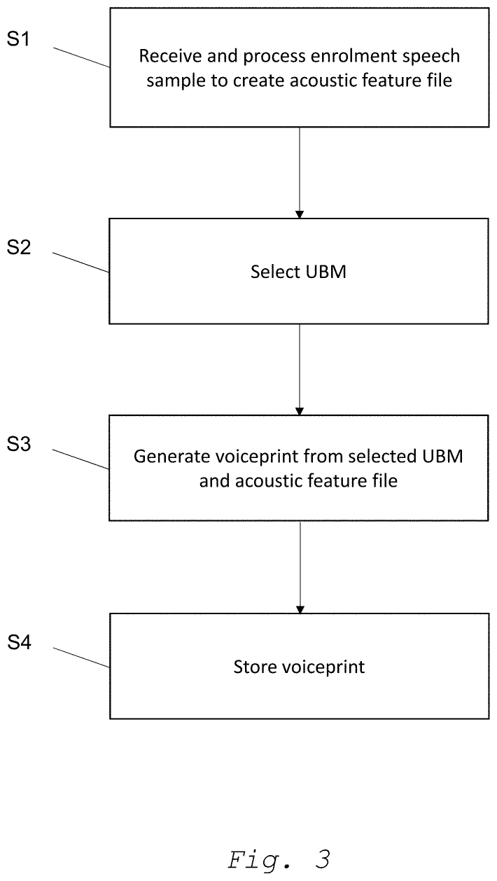

Before describing techniques for setting individual score thresholds for achieving a target false accept rate, a basic process flow for enrolling voice samples so as to generate a user's initial voiceprint will be described with reference to FIG. 3.

At step S1 an enrolment speech sample for a user is received by the system 102 in a suitable file format (e.g. as a wav file, or any other suitable file format). The voice processing system 102 (and more particularly the processing unit 114) unpacks the voice data from the voice file and stores a corresponding acoustic feature file in the enrolled file database 122. The stored acoustic feature file (hereafter “enrolled file”) is indexed in association with the user identity stored in the identity management database 120. Verification samples provided by the user during the authentication process (which may, for example, be a passphrase, account number, etc.) are also unpacked and stored as enrolled files over time as the user interacts with the voice processing system 102.

At step S2 a Universal Background Model (hereafter referred to as a UBM) is selected from the seed UBM database 126. According to the illustrated embodiment, the seed UBM database 126 stores a plurality of different seed UBMs. A UBM model is produced from a large cohort of speakers with a Gaussian mixture model (GMM) typically containing hundreds or thousands of Gaussian mixtures.

Each seed UBM has been trained from a cohort of speakers that share one or more particular acoustic characteristics, such as language, accent, gender, age, channel, etc.). Thus, the selection of seed UBM for the user being enrolled with the system 102 involves selecting a seed UBM that best matches the particular acoustic characteristics of the user. For example, where the user is a European male the system may select a seed UBM which has been built from a population of European male speakers. The system may determine an acoustic characteristic of the user by way of an evaluation of the enrolled file, using techniques well understood in the art. It will be understood that any number of different seed UBMs may be selectable, depending only on the desired implementation.

At step S3 the voice biometric engine 116 processes the stored enrolled file and the selected UBM in order to generate a voiceprint for the user, using techniques well understood by persons skilled in the art. It will be understood that the system 102 may request and process additional enrolled files for that user (i.e. derived from other speech samples) until a sufficient number of enrolled files have been processed to generate an accurate voiceprint.

At step S4, the voiceprint is loaded into the voiceprint database 124 for subsequent use by the voice biometric engine 116 during a user authentication process.

It will be understood that steps S1 through S4 are repeated for each new user enrolling with the system 102.

Operating Principles

As mentioned in the preamble, voice authentication systems have an operating point (at system level) that determines the rates of false accepts (FA) and false rejects (FR). This point can be chosen arbitrarily, such as at the equal error rate (EER), or the operating point can be chosen to meet a given security objective, such as an FA rate of 0.001.

A given FA security objective will necessarily produce a corresponding FR rate. In this setting, the overall system performance is then governed by the FR rate, the lower the better. However, overall system performance can overlook the security characteristics of individual voiceprints. By finding an operating point for each individual voiceprint (i.e. an optimised individual threshold level for voice authentication) it is possible to provide confidence of voiceprint security across all users, while at the same time increasing the overall system performance. Embodiments take advantage of this realisation.

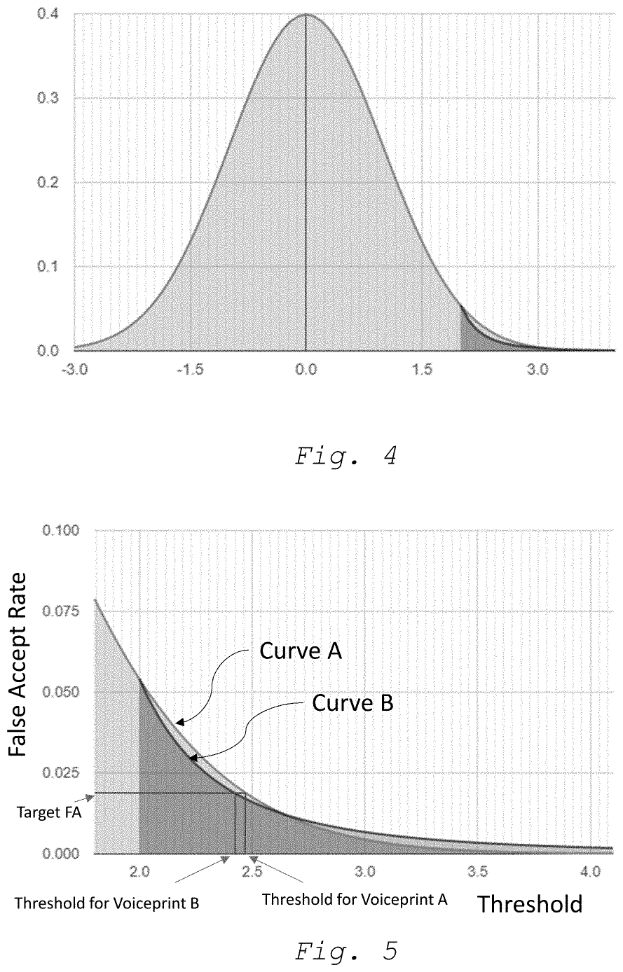

In more detail, the distribution of scores resulting through testing numerous impostor acoustic features files against a voiceprint is approximately normal (Gaussian). This is shown in FIG. 4, which graphs a distribution for two different voiceprints.

For score estimates near the mean (within about 1 standard deviation) then the Gaussian assumption provides a reasonably good approximation. However, at the tails the distribution is significantly skewed with each voiceprint is skewed in its own way. As shown in FIG. 4, the vast majority of scores are relatively low and located in the body of the distribution. As a consequence, they contribute little or nothing to the estimations associated with the tail of the curve (i.e. in which the FA threshold is typically located).

FIG. 5 is a close-up view of the tail portions of the two voiceprint curves (curve A and curve B) of FIG. 4, close to a target FA operating point. FIG. 5 serves to illustrate the variance in the two tails and the relatively small number of scores that fall in that part of the distribution.

Thus, embodiments described herein rely on initially determining an appropriate number of impostor samples to evaluate for accurately determining the tail of an impostor distribution (which then enables the determination of an individual threshold for achieving a target FA rate).

According to a first embodiment, a large number of impostor files are selected to ensure the tale estimation is accurate. According to a particular embodiment, the following equation can be applied to determine the number of impostor feature files that need for accurate FA estimation:

Points=5/FA Rate (Equation 1)

For example, applying equation 1, for a target FA rate of 1 in 1000, at least 5000 points are required for sampling. It will be understood that greater of fewer points can be applied, though this may impact on the confidence level of the calculation (i.e. the ability to accurately plot the tail of the distribution curve at or near the target FA point, typically 1:1000 to 1:10,000 region).

The descending ordered set of scores produced by the impostor feature files is used to estimate the threshold for a target FA rate. For 5000 test statistics and FA of 0.001 then the estimated threshold is the value of the fifth highest impostor feature file score. Nearby scores are used to approximate the tail of the distribution to increase the confidence interval for setting a FA rate of 0.001.

In an alternative embodiment to that described above, a fewer number of impostor files may be utilised while still maintaining accuracy in the tail estimation. According to the alternative embodiment, as the impostor testing is run, the processing module 114 dynamically evaluates the scores to identify those impostor speakers that achieved a “high” score (i.e. greater than some predefined threshold, e.g. 86%). If those impostors have additional voice files or acoustic feature files stored in the database 128, then the processing module 114 can select those files for impostor testing, as they are likely to also give high scores and increase the resolution of the tail of the score distribution and provide an accurate estimation of the threshold to achieve the target FA rate using fewer impostor feature files and fewer calculations.

Setting Individual Voiceprint Thresholds for Achieving a Target FA Rate

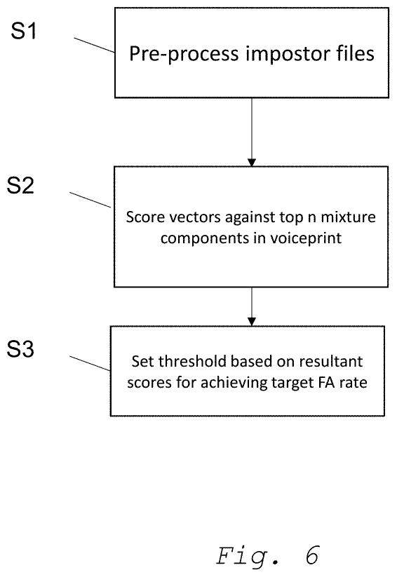

A process for setting an individual threshold for achieving a target system FA rate will now be described with reference to the flow diagram of FIG. 6.

As discussed above, the method described herein involves carrying out impostor testing on individual voiceprints using impostor files. This can take a great deal of time, particularly when processing large numbers of enrolled files and when the number of GMM mixtures is large. Embodiments described herein draw on the realisation that the vast majority of mixtures do not affect the final authentication score and can be eliminated from the calculation without effecting the result.

According to a first step (S1) of the present invention, prior to carrying out a target threshold calculation procedure for a voiceprint, the impostor voice files are pre-processed. Pre-processing may be carried out in a batch process prior to impostor testing, or can be carried out on individual impostor voice files as they are stored in the database 118. In more detail, pre-processing involves the voice biometric engine 116 calculating the impostor acoustic feature files from each of the impostor voice files.

Still at step S1, for each impostor acoustic file, each mixture of each UBM stored in the UBM database 126 is scored against the individual feature vectors (or other suitable parameters associated with the individual acoustic features) in the corresponding impostor feature file and a selected number n of high scoring mixtures (i.e. the mixture components that most greatly impact on the final mixture score) are determined. Persons skilled in the art will appreciate that the number n may vary for different impostor feature files and for different UBMs. For example, one impostor feature file may have 3 mixture components that impact on the final mixture score, while another may have 10. Typically, the number ranges between 1 and 10, although the number may be greater depending on the features of the voiceprint and the UBM from which it was adapted. It will be understood that the processing module 114 may implement various rules (stored in the rule store 130) to determine whether or not the mixtures contributed sufficiently to achieve a “high” score. For example, the system may set a threshold value that the score must be greater than in order to be considered as a “high score”. In an alternative embodiment, the number n may be fixed (e.g. the processing module 114 will always determined the top 10 scoring mixtures).

Once the calculation is completed, the engine 116 stores the index to the top n mixtures with each impostor acoustic feature file.

At step S2, the impostor testing process is implemented when enrolling a new voiceprint. As a person skilled in the art would be aware, the voiceprint is created with reference to a particular UBM. In general terms, the target threshold calculation comprises comparing multiple impostor acoustic feature files against the newly created voiceprint and the particular UBM with the resultant scores being recorded and used for estimating the tail distribution required to determine the threshold to achieve the target False accept rates. However, when performing the UBM part of the calculation embodiments described herein only utilise the top n mixtures of the UBM (as identified at step S1), thereby significantly reducing the number of calculations required to generate the scores.

A system wide impostor testing process is described in published PCT Patent Application No. PCT/AU2009/000920 (to the same applicant), the contents of which are incorporated herein by reference.

As mentioned above, the number of impostor feature files tested by the engine 116 may vary depending on the desired implementation, however according to the illustrated embodiment at least 10,000 impostor feature files are tested.

In an alternative embodiment, rather than selecting the top n mixtures when carrying out the impostor testing, the processing module 114 may instead select a number of mixtures that results in a predefined “probability mass” (e.g. 98%). That is, the processing module 114 only carries out a sufficient number of calculations to reach a predetermined “probability mass”. This may result in a more accurate and efficient calculation than simply setting n top mixtures. By way of example, in some voiceprint UBM's combinations (also referred to as acoustic models), there may be one or two top mixtures. If n is set to 10 then the processing module 114 is performing eight calculations that do not contribute to the fixed FA result. On the other hand, there may be acoustic models that have meaningful information in the top 20 mixtures. If only the top 10 mixtures are utilised, then the result will not be as accurate as it could be.

At step S3, based on the resultant distribution of scores, the engine 116 determines the threshold to meet the target FA rate for the newly enrolled voiceprint. The threshold is selected from the distribution curve produced from an extrapolation of the distribution of scores, especially where it relates to the tail of the distribution which is the typical operating point for a voice biometric security system. In FIG. 5 shows the threshold setting process and illustrates different thresholds for Voiceprint A (relating to the distribution of scores for voiceprint A) and Voiceprints B for a Target FA. In an embodiment the rule store 130 is evaluated to determine the FA rate based on the input score distribution.

It will be understood that steps S2 and S3 may be implemented in real time (e.g. during enrolment of the voiceprint with the system).

In an embodiment a target FA rate can be set at 1 in every Y for the individual voiceprint, such that a cohort of impostor voice files contains at least a multiple of Y impostor voice files.

In an embodiment, in response to determining that the true speaker false reject (FR) rate is greater than the required true speaker FR rate, the method further comprises re-enrolling the voiceprint or adjusting a security threshold for the user or flagging that this voiceprint does not meet the target security requirement.

In an embodiment, step S1 is implemented prior to enrolment of the voiceprint with the system.

As mentioned above, embodiments can be achieved at runtime since only the top n mixtures are computed for each frame, rather than all mixtures (which typically results in a 50 times reduction in CPU use). By parallelising the verifications across many CPUs it is possible to determine the impostor distribution (10,000 impostor data points) for an individual voiceprint in under 80 milliseconds. 10,000 data points gives enough resolution to accurately determine the threshold for 0.0005 (1 in 2000). Similarly, 50,000 data points gives enough resolution for a threshold at FA of 0.0001 (1 in 10000) and would take less than 0.5 seconds on 36 virtual CPU machine.

The impostor data generated as above may be pre-processed offline for bootstrapping a newly installed system. In a live deployment, impostor data can be generated at each enrolment to be used for future enrolments since it more closely matches expected genuine impostors. Eventually, the bootstrap data is not required and all impostor data is taken from enrolments.

Although embodiments described in preceding paragraphs described the processing system 102 in the form of a “third party”, or centralised system, it will be understood that the system 102 may instead be integrated into the secure service provider system 104.

While the invention has been described with reference to the present embodiment, it will be understood by those skilled in the art that alterations, changes and improvements may be made and equivalents may be substituted for the elements thereof and steps thereof without departing from the scope of the invention. In addition, many modifications may be made to adapt the invention to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiment described herein and will include all embodiments falling within the scope of the independent claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for achieving a target false acceptance (FA) rate by setting individual acceptance thresholds for respective voiceprints used for enrolling users with a biometric authentication system, each individual voiceprint derived from a Universal Background Model (UBM) selected by the system, the method comprising:
(a) selecting a cohort of impostor voice files containing voice samples spoken by persons other than the enrolling user;
(b) determining one or more feature vectors for each voice file in the selected cohort of impostor voice files;
(c) determining and selecting, for each feature vector of each impostor voice file, GMM mixture components for the selected Universal Background Model (UBM);
(d) scoring the acoustic parameter vectors against only a predefined number of the top n mixture components in the individual voiceprint to generate a distribution of impostor scores; and
(e) evaluating the resultant distribution to determine an acceptance threshold for achieving the target FA rate.

2. A method in accordance with claim 1, wherein steps (d) and (e) are implemented in real time during enrolment with the system.

3. A method in accordance with claim 1, further comprising setting a target FA rate at 1 in every Y for the individual voiceprint, where Y is the number of imposter files.

4. A method in accordance with claim 3, further comprising selecting a cohort of impostor voice files that contains at least a multiple of Y impostor voice files.

5. A method in accordance with claim 1, wherein, in response to determining that the false reject (FR) rate is greater than the target FR rate, the method further comprises regenerating the individual voiceprint or adjusting a security threshold for the user.

6. A method in accordance with claim 1, wherein n comprises between 1 and maximum number of mixture components available, but usually some number less than the maximum number of mixture components available.

7. A method in accordance with claim 1, wherein steps (a) to (c) are implemented prior to enrolment.

8. A method for setting an acceptance threshold for an individual voiceprint to achieve a target false acceptance (FA) rate of a biometric authentication system, the method comprising:
(a) selecting a cohort of acoustic feature files derived from voice samples spoken by persons other than the enrolling user;
(b) for each acoustic feature file, determining a subset of mixture components for at least one UBM implemented by the system to be used in an impostor testing process;
(d) implementing an impostor testing process, the impostor testing process comprising implementing a biometric authentication engine to compare each acoustic feature file against the enrolled voiceprint using only the subset of mixture components; and
(e) setting the threshold based on an evaluation of one or more scores resulting from the comparisons.

9. A computer system for setting an acceptance threshold for an individual voiceprint to achieve a target false acceptance (FA) rate of a biometric authentication system, the system comprising a processing module operable to:
(a) select a cohort of acoustic feature files derived from voice samples spoken by persons other than the enrolling user;
(b) for each acoustic feature file, determine a subset of mixture components for at least one UBM implemented by the system;
(d) implement an impostor testing process, the impostor testing process comprising implementing a biometric authentication engine to compare each acoustic feature file against the enrolled voiceprint utilising only the subset of mixture components; and
(e) setting the threshold based on an evaluation of one or more scores resulting from the comparisons.

10. A system in accordance with claim 9, wherein step (b) comprises implementing the biometric engine to score each mixture of the at least one UBM against individual acoustic features in the corresponding impostor acoustic feature file.

11. A system in accordance with claim 10, wherein the subset of mixture components comprises components that exceeded a threshold score.

12. A system in accordance with claim 9, wherein step (b) comprises determining and ranking, for each acoustic feature in the acoustic feature file, GMM mixture components for the at least one Universal Background Model (UBM) and wherein the subset comprises a predefined number of top ranking mixture components.

13. A system in accordance with claim 9, wherein step (b) comprises determining and ranking, for each acoustic feature in the acoustic feature file, GMM mixture components for each Universal Background Model (UBM) implemented by the system and wherein the subset comprises a predefined number of top ranking mixture components for each UBM.
